(19) United States
(12) Patent Application Publication
(10) Pub. No.: US 2026/0286096 A1
(43) Pub. Date: Sep. 24, 2026

(54) THERMOSETTING RESIN COMPOSITION AND METHOD FOR PREPARING THE SAME

(71) Applicants: HYUNDAI MOTOR COMPANY, SEOUL (KR); KIA CORPORATION, SEOUL (KR); Seoul National University R&DB Foundation, Seoul (KR)

(72) Inventors: Mun Kyu Lee, Hwaseong-si (KR); Woong Ryeol Yu, Gwangmyeong-si (KR); Ga Young Kim, Anyang-si (KR); Do Young Kim, Seongnam-si (KR)

(73) Assignees: HYUNDAI MOTOR COMPANY, SEOUL (KR); KIA CORPORATION, SEOUL (KR); Seoul National University R&DB Foundation, Seoul (KR)

(21) Appl. No.: 19/571,076

(22) Filed: Mar. 18, 2026

(30) Foreign Application Priority Data
Mar. 20, 2025 (KR) 10-2025-0036084
Sep. 15, 2025 (KR) 10-2025-0131758

(51) Int. Cl. C08K 3/36; C08G 18/38; C08J 3/21

(52) U.S. Cl. CPC C08K 3/36; C08G 18/3814; C08J 3/212; C08J 2375/12; C08K 2201/011

(57) ABSTRACT

A thermosetting resin composition, which includes polyurethane-based resin and silica nano-particles, in which the silica nano-particles are included in a content ranging from 1.5 parts by weight to 2.5 parts by weight, based on 100 parts by weight of the polyurethane-based resin, and a method for preparing the same.

### CROSS-REFERENCE TO RELATED APPLICATION

This application claims the benefit of priority to Korean Patent Application No. 10-2025-0036084, filed in the Korean Intellectual Property Office on Mar. 20, 2025, and Korean Patent Application No. 10-2025-0131758, filed in the Korean Intellectual Property Office on Sep. 15, 2025, the entire contents of which are incorporated herein by reference.

### TECHNICAL FIELD

The present disclosure provides thermosetting resin composition and a method for preparing the same.

### BACKGROUND

Various functional attachments have been used in the vehicle industry to absorb the impact between parts during the assembling of parts having heavier weight or to help fix a position. In particular, when a part, a door, a trunk, or a window of a vehicle body is assembled, an attachment is required to support a part at a specific position or to adjust the gap between parts, thereby preventing the interference between parts and ensuring the precision of an assembling process.

Such an attachment is typically attached to an attaching surface. Accordingly, the attachment requires mechanical strength and durability beyond a specific minimal level, such that the shape and the function of the attachment is maintained even though the contacts between the parts or impact on the parts are repeated. Conventionally, the attachment mainly includes polyurethane-based thermoplastic resin or rubber-based material. In addition, there is also examples in which fluororubber or unsaturated urethane resin is applied to the attachment to improve durability and stiffness.

However, such a conventional urethane attachment may not have sufficient stiffness and hardness when used in a confined space and/or in parts having complicated shape and may be limited in reducing a thickness or a dimension to a specific value, as a smaller or thinner attachment is required. Accordingly, the material is limited to a small range of applicable parts, and decreases the degree of freedom in design.

Conventional attachment technology also has a problem in that the performance can rapidly deteriorate under repetitive load or depending on the replacement cycle, and the micro-machining for the same specification is difficult, which in turn makes it difficult to secure uniformity and quality in manufacturing. While a metal plate can be inserted into a product to try to reinforce the structure this strategy conflicts with other performance characteristics such as external impact absorbance or surface paintability. Accordingly, metal reinforcement may not be useful when applied to a process for producing a vehicle. In addition, if higher-priced special resins or composition materials are needed in order to provide for the necessary material strength, costs of the source material and manufacturing increase.

Accordingly, there is needed to develop a new resin composition that allows for sufficient attachment properties, adjustability for the design of complicated shapes, and can maintain stable mechanical characteristics even under a repetitive load, and/or provide improved productivity and economic efficiency.

### SUMMARY

The present disclosure addresses the above-mentioned problems associated with the state of art while maintaining certain advantages achieved by the existing technology.

An aspect of the present disclosure provides a thermosetting resin composition, which can exhibit any one or more of higher elasticity, higher mechanical strength, improved heat resistance, good processibility, and good reliability. The thermosetting resin composition can comprise an effective distribution of silica nano-particles in thermoplastic polyurethane-based resin, as described generally herein.

Another aspect of the present disclosure provides a method for preparing a thermosetting resin composition in accordance with the disclosure.

The technical problems to be solved by the present disclosure are not limited to the aforementioned problems, and other technical problems not specifically mentioned herein will be understood from the following description by those skilled in the art to which the present disclosure pertains.
(1) In embodiments, the present disclosure provides thermosetting resin composition which includes polyurethane-based resin and silica nano-particles, in which the silica nano-particles are included in a content ranging from 1.5 parts by weight to 2.5 parts by weight, based on 100 parts by weight of the polyurethane-based resin.
(2) In embodiments, the present disclosure provides thermosetting resin composition, in accordance with embodiment (1), in which the polyurethane-based resin includes one or more of, or is selected from one or more of the group consisting of, polyester-based polyurethane, polyether-based polyurethane, and/or polycarbonate-based polyurethane.
(3) In embodiments, the present disclosure provides thermosetting resin composition, in accordance with any of embodiments (1) or (2), in which the silica nano-particles have an average particle diameter ranging from 10 nm to 20 nm.
(4) In embodiments, the present disclosure provides thermosetting resin composition, in any one of (1) to (3), in which the silica nano-particles are included in a content ranging from 1.8 parts by weight to 2.3 parts by weight, based on 100 parts by weight of the polyurethane-based resin.
(5) In embodiments, the present disclosure provides a method for preparing thermosetting resin composition, which includes vacuum-degassing each of thermoplastic polyurethane and a curing agent (S1), mixing the vacuum-degassed thermoplastic polyurethane, the vacuum-degassed curing agent, and silica nano-particles to form a mixture (S2), and vacuum-degassing the mixture (S3), in which the silica nano-particles are introduced in a content ranging from 1.5 parts by weight to 2.5 parts by weight, based on 100 parts by weight of the vacuum-degassed thermoplastic polyurethane.
(6) In embodiments, the present disclosure provides a method for preparing thermosetting resin composition in accordance with embodiment (5), in which the curing agent includes one or more type of, or is selected from the group consisting of, an isocyanate-based curing agent and an amine-based curing agent.
(7) In embodiments, the present disclosure provides a method for preparing thermosetting resin composition in accordance with any of embodiments (5) or (6), in which the curing agent is vacuum-degassed at a temperature ranging from 100° C. to 150° C.
(8) In embodiments, the present disclosure provides a method for preparing thermosetting resin composition, in accordance with any of embodiments (5) to (7), in which the thermoplastic polyurethane is vacuum-degassed at a temperature ranging from 50° C. to 100° C.
(9) In embodiments, the present disclosure provides a method for preparing thermosetting resin composition, in accordance with any of embodiments (5) to (8), in which the vacuum-gassed curing agent is included in a content ranging from 10 parts by weight to 15 parts by weight, based on 100 parts by weight of the vacuum-degassed thermoplastic polyurethane.
(10) In embodiments, the present disclosure provides a method for preparing thermosetting resin composition, in accordance with any of embodiments (5) to (9), in which the mixture is vacuum-degassed at a temperature ranging from 50° C. to 80° C.

### BRIEF DESCRIPTION OF THE DRAWINGS

The above and other objects, aspects, embodiments, features and advantages of the present disclosure will be more apparent from the following detailed description taken in conjunction with the accompanying drawings:

FIG. 1 illustrates stress-strain curves representing tensile properties of resin compositions according to Example 1, Comparative example 1, and Comparative example 2.

### DETAILED DESCRIPTION

Hereinafter, the present disclosure will be described in more detail for the understanding of the present disclosure.

The above and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 10, 0.5%, 0.1%, 0.05%, or 0.01% of the stated value.

### Thermosetting Resin Composition

The present disclosure provides a thermosetting resin composition (alternatively referred to as a “resin composition”).

According to an embodiment of the present disclosure, the thermosetting resin composition includes polyurethane-based resin and silica nano-particles, with the silica nano-particles in an amount ranging from 1.5 parts by weight to 2.5 parts by weight, based on 100 parts by weight of the polyurethane-based resin.

According to an embodiment of the present disclosure, the thermosetting resin composition may include the polyurethane-based resin and the silica nano-particles. In further embodiments, the thermosetting resin composition may be formed by dispersing the silica nano-particles in the polyurethane-based resin. Included in particular amounts, the silica nano-particles may improve curing stability of the polyurethane-based resin (alternatively referred to as “resin”) during a curing process, and minimize variations in product quality by increasing the uniformity and reproducibility of the curing reaction. Accordingly, the silica nano-particles may provide resin compositions capable of increasing the reliability of a joint part even under repetitive loads or impact, and may enhance durability by suppressing deterioration in physical properties even during long-term use. Furthermore, the silica nano-particles in the resin composition may further increase the wear resistance and chemical resistance of the polyurethane-based resin, such that excellent performance is exhibited even under various environmental conditions typical of a vehicle body. In contrast, conventional polyurethane-based resin compositions having no silica nano-particle may exhibit lower mechanical strength and durability when such a conventional polyurethane-based resin composition is exposed to long-term use or repetitive loads. Accordingly, conventional technology can result in joint parts that may crack or de-laminate, thereby reducing the assembly quality and reliability of the vehicle body. In addition, even when a reinforcing material is added to conventional resin composition, the physical properties may not be uniform because the reinforcing material may not be uniformly dispersed. Accordingly, stress is locally concentrated and can limit improvement in mechanical performance.

According to an embodiment of the present disclosure, the polyurethane-based resin may include one or more of, or may be selected from the group consisting of, polyester-based polyurethane, polyether-based polyurethane, and/or polycarbonate-based polyurethane. In some example embodiments, the polyurethane-based resin may be poly(tetramethylene ether)glycol. The polyurethane-based resin may exhibit excellent physical properties, e.g., mechanical strength, heat resistance, moisture resistance, and chemical resistance which can depend on the structural characteristics of each molecular structure, such that the physical properties are more effectively controlled depending on the use and the required performance of the resin composition.

According to an embodiment of the present disclosure, the thermosetting resin composition may include silica nano-particles in an amount ranging from 1.5 parts by weight to at most 2.5 parts by weight, based on 100 parts by weight of the polyurethane-based resin. In specific embodiments, the thermosetting resin composition may include silica nano-particles, in an amount of at least 1.5 parts by weight, at least 1.6 parts by weight, at least 1.7 parts by weight, at least 1.8 parts by weight, at least 1.9 parts by weight, at least 2.0 parts by weight, or at least 2.1 parts by weight, and in other embodiments may be included in a content of at most 2.5 parts by weight, at most 2.4 parts by weight, or at most 2.3 parts by weight, based on 100 parts by weight of the polyurethane-based resin. In embodiments the thermosetting resin composition includes silica nano-particles in the above ranges, so as to allow the silica nano-particles to be uniformly dispersed in the resin. Accordingly, the thermosetting resin composition may exhibit improved mechanical strength and/or durability. In additional embodiments, the resin may avoid increased viscosity, irregular curing, or lowered processibility which might be due to an excess amount of silica nano-particles (i.e., above the ranges described above), and thus provide an effective reinforcing material. Alternatively, when the thermosetting resin composition includes silica nano-particles lower than the limit of the ranges above, absolute content of silica nano-particles included in the resin can become insufficient. This can be exhibited by lack of sufficient reinforcing effect. Similarly, when the thermosetting resin composition includes silica nano-particles beyond the upper limit of the range above, the silica nano-particles may aggregate or the viscosity of the silica nano-particles may increase such that the silica nano-particles are not uniformly dispersed in the resin. This can result in the resin being irregularly cured, having degraded processability, or de-laminated at the interface.

According to an embodiment of the present disclosure, the average particle diameter of the silica nano-particles may range from 10 nm to 20 nm. In specific embodiments, the average particle diameter of the silica nano-particles may be at least 10 nm, at least 11 nm, at least 12 nm, at least 13 nm, at least 14 nm, or at least 15 nm, and in other embodiments may be at most 20 nm, at most 19 nm, at most 18 nm, at most 17 nm, or at most 16 rim. When the average particle diameter of the silica nano-particles fall within the above range, the silica nano-particles may be easily dispersed in the polyurethane-based resin, without being aggregated, and can effectively bind to the continuous matrix structure of the resin which can increase or maximize any mechanical reinforcing effect. In addition, the range of the average particle diameter of the silica nano-particles minimizes any influence the silica nano-particles have on viscosity of the resin composition, while maintaining the stable processability and curing characteristics of the resin composition.

### <Molded Product>

The present disclosure provides a molded product from the thermosetting resin composition.

According to an embodiment of the present disclosure, the thermosetting resin composition may resist or avoid cracking, as the silica nano-particles are uniformly dispersed. Accordingly, the thermosetting resin composition may exhibit excellent properties in lifespan (avoiding fatigue) and impact resistance, such that the thermosetting resin composition is applicable to materials for a variety of structures. For example, the molded product may be applicable to an interior material, a bumper beam, or an energy absorption structure, which typically need to endure higher load and be able to absorb deformation to a greater degree relative to other parts of transportation equipment such as a vehicle, an aircraft, and a railway vehicle.

Specifically, the molded product according to an embodiment of the present disclosure may be employed as an attachment to precisely fix parts, such as a door, a fender, or a roof panel, and to secure a function for preventing corrosion and blocking noise in a process of assembling a vehicle body.

In general, the attachment can simultaneously satisfy injection moldability, adhesion, durability, and impact-absorbing characteristics to meet the automation and the high-speed production condition of a vehicle production line. In particular embodiments, product minimizes the interference between parts in a confined space while maintaining higher mechanical strength. Accordingly, ensuring the uniformity of physical properties of the resin composition and the curing stability of the resin are factors that provide such advantageous properties to molded products containing the resin composition.

Conventionally, a resin based on thermoplastic polyurethane (TPU) or a fluorine-based urethane product has been used for the attachment. However, the resin based on thermoplastic polyurethane (TPU) or the fluorine-based urethane product can be limited in its reliability, e.g., for a joint part, due to the degradation of the physical properties and the insufficient resistance against the repetitive loads during long-term use. In addition, even though a reinforcing material can be added, ensuring the necessary dispersion of the silica nano-particles in the resin is difficult, which limits the mechanical performance.

Accordingly, the inventors developed a resin composition that provides improved mechanical strength and durability by maintaining a particular ratio of the silica nano-particles that are dispersed in a polyurethane-based resin. In embodiments, the vacuum-degassing and mixing processes can be modified and optimized throughout the whole preparing process of the thermosetting resin composition, which can prevent the silica nano-particles from being aggregated, and allow for stable dispersing of the silica nano-particles in the resin, such that any potential limitation in the performance is effectively overcome.

### Method for Preparing Thermosetting Resin Composition

Another aspect of the present disclosure provides a method for preparing the thermosetting resin composition in accordance with the aspects and embodiments of the disclosure.

According to an embodiment of the present disclosure, the method for preparing the thermosetting resin composition includes vacuum-degassing each of a thermoplastic polyurethane and a curing agent (S1), mixing the vacuum-degassed thermoplastic polyurethane, the vacuum-degassed curing agent, and silica nano-particles to form a mixture (S2), and vacuum-degassing the mixture (S3). In embodiments, the silica nano-particles are introduced in an amount ranging from 1.5 parts by weight to 2.5 parts by weight, based on 100 parts by weight of the vacuum-degassed thermoplastic polyurethane.

Hereinafter, the method for preparing the thermosetting resin composition according to the present disclosure will be described as a step-wise process merely for purposes of illustration and clarity. Other methods may be used.

### ‘S1’

According to an embodiment of the present disclosure, the method for preparing the thermosetting resin composition includes vacuum-degassing each of the thermoplastic polyurethane and the curing agent (S1).

According to an embodiment of the present disclosure, degassing may prevent quality degradation of the final composition by preemptively removing internal bubbles that may be produced in the process for preparing the thermosetting resin composition. As the thermoplastic polyurethane and the curing agent may make contact with air in the preparing, storing, or handing process, or external air is introduced into the thermoplastic polyurethane-based resin and the curing agent in the preparing, storing, or handing process, fine bubbles may be produced. If the bubbles remain, the performance of the thermoplastic polyurethane may suffer, e.g., exhibit irregular curing, the mechanical strength of the thermoplastic polyurethane may be degraded, or an interface defect may be caused in the thermoplastic polyurethane. Accordingly in embodiments, each of the thermoplastic polyurethane and the curing agent is individually foamed in a vacuum-state, thereby preventing or reducing air bubbles from being introduced in the resin composition in advance, and ensuring the stability in the down-stream process.

According to an embodiment of the present disclosure, ‘the vacuum-degassing’ process does not necessarily require a complete vacuum state, but may include any and all degassing processes which effectively remove bubbles (e.g., trapped bubbles, dissolved gas, etc.) from the resin composition under a pressure lower than atmospheric pressure (about 101.3 kPa), that is, under a low-pressure state. In specific embodiments, the vacuum-degassing process may be performed under conditions of about at most 10 kPa, and ranging to at most 1 kPa, and may employ a higher-vacuum condition at a level of several tens of Pa depending on process conditions and viscosity of the composition. Under such a lower-pressure environment, the size of bubbles may be expanded and the rising speed of the bubbles may be increased, thereby effectively removing fine bubbles from the resin composition.

According to an embodiment of the present disclosure, the vacuum-degassing process is not limited to any specific method or equipment. A vacuum-degassing process may be selected depending on the viscosity of a material for vacuum-degassing, a bubble containing state, and a fabricating process condition. For example, methods such as static vacuum degassing, dynamic vacuum degassing, or reduced-pressure degassing may be applied, and each method may have advantages and disadvantages depending on a particular composition, treatment target, and/or process efficiency. Accordingly, the method for the vacuum-degassing process may be selected depending on the particular characteristics of the composition and intended purpose of the end-product(s).

According to an embodiment of the present disclosure, the thermoplastic polyurethane may be vacuum-degassed at a temperature ranging from 50° C. to 100° C. In specific embodiments, the thermoplastic polyurethane may be vacuum-degassed at a temperature of at least 50° C., at least 55° C., at least 60° C., at least 65° C., at least 70° C., or at least 75° C., and in other embodiments may be vacuum-degassed at a temperature of at most 100° C., at most 95° C., at most 90° C., at most 85° C., or at most 80° C. When the thermoplastic polyurethane is vacuum-degassed at the temperature range, the viscosity of the thermoplastic polyurethane may be effectively reduced. Accordingly, the fine bubbles contained in the resin may induced to a flowable state such that the fine bubbles are raised to the outside/surface and easily removed. Accordingly, residual bubbles are prevented which can avoid problems such as non-uniformity of physical properties, interface defects, and decrease in mechanical strength in subsequent mixing and curing processes. In addition, the temperature range can provide for the thermal stability of thermoplastic polyurethane to prevent the components from being decomposed due to higher temperature or to prevent an unexpected earlier reaction with the curing agent from occurring.

According to an embodiment of the present disclosure, the curing agent may be vacuum-degassed at a temperature ranging from 100° C. to 150° C. In specific embodiments, the thermoplastic polyurethane may be vacuum-degassed at a temperature of at least 100° C., at least 105° C., at least 110° C., at least 115° C., or at least 120° C., and in other embodiments may be vacuum-degassed at a temperature of at most 150° C., at most 145° C., at most 140° C., at most 135° C., or at most 130° C. When the curing agent is vacuum-degassed at the temperature in the above range, the viscosity of the curing agent may be properly reduced such that the bubbles in the resin are in a flowable state and readily raised and removed. Accordingly, removing any residual bubbles can effectively prevent the curing agent from being irregularly cured, prevent the mechanical strength of the curing agent from being reduced, and prevent the interface defect of the curing agent in the subsequent mixing and curing processes. In addition, the temperature range can provide for the thermal stability of the curing agent to prevent the curing agent from being chemically decomposed due at higher temperature or to prevent an unexpected earlier curing reaction, thereby maintaining the quality and the reliability of the thermosetting resin composition.

According to an embodiment of the method, the curing agent may include one or more of, or may be selected from the group consisting of, an isocyanate-based curing agent and/or an amine-based curing agent. Suitable curing agents can exhibit excellent reactivity with the polyurethane-based resin to form a uniform network structure. In addition, suitable curing agents may provide for stable physical properties, and can improve the flexibility of a preparing process and the reliability of an applied product.

### ‘S2’

According to an embodiment, the method comprises mixing the vacuum-degassed thermoplastic polyurethane, the vacuum-degassed curing agent, and the silica nano-particles to form a mixture (S2).

According to an embodiment of the present disclosure, the mixing can effectively disperse the silica nano-particles into the thermoplastic polyurethane-based resin by uniformly mixing the vacuum-degassed thermoplastic polyurethane, the vacuum-degassed curing agent, and the silica nano-particles. As the silica nano-particles are uniformly mixed with the thermoplastic polyurethane-based resin, the silica nano-particles avoid aggregation in the resin which can prevent stresses from being concentrated and to prevent interface defects during the curing process.

According to an embodiment of the method, the vacuum-degassed curing agent may be included an amount ranging from 10 parts by weight to 20 parts by weight, based on 100 parts by weight of the vacuum-degassed polyurethane. In specific embodiments, the vacuum-degassed curing agent may be included an amount of at least 10.0 parts by weight, at least 10.5 parts by weight, at least 11.0 parts by weight, at least 11.5 parts by weight, or at least 12.0 parts by weight, or in other embodiments included an amount of at most 20.0 parts by weight, at most 19.5 parts by weight, at most 19.0 parts by weight, at most 18.5 parts by weight, at most 18.0 parts by weight, or at most 17.5 parts by weight, based on 100 parts by weight of the vacuum-degassed polyurethane. When the content of the vacuum-degassed curing agent falls within the above range, the curing agent may be maintained in a proper content in the composition and allows for an effective curing reaction. Accordingly, the curing speed and the curing uniformity may be modified and/or optimized, which can improve the mechanical strength and the durability of the thermosetting resin composition at the final stage.

### ‘S3’

According to an embodiment of the present disclosure, the method includes vacuum-degassing the mixture (S3).

According to an embodiment of the present disclosure, degassing the mixture can remove fine bubbles newly introduced or produced in the mixing process of ‘S2’, and can minimize residual bubbles in the resin composition at the final stage. A thermosetting resin composition having any bubbles removed through ‘S3’ may reduce the occurrence of interface defects and irregular physical properties during the curing process, and can improve the mechanical strength and the durability. In addition, the vacuum-degassing process can increase the uniformity of the structure of the composition, and increase the stability in the subsequent molding process and curing process, thereby maintaining uniform quality of the product.

According to an embodiment of the present disclosure, the vacuum-degassing of the mixture in ‘S3’ employs the same methods and equipment as used in the ‘vacuum-degassing’ in earlier methods steps (i.e., ‘S1’ that degasses the curing agent and/or resin).

According to an embodiment of the present disclosure, the mixture may be vacuum-degassed at a temperature ranging from 50° C. to 80° C. In specific embodiments, the mixture may be vacuum-degassed at a temperature of at least 50° C., at least 52° C., at least 54° C., at least 56° C., at least 58° C., or at least 60° C. In additional embodiments, the mixture may be vacuum-degassed at a temperature of at most 80° C., at most 75° C., at most 70° C., or at most 65° C. When the mixture is vacuum-degassed in these temperature ranges, the viscosity of the mixture may be reduced allowing for simple removal of the fine bubbles remaining in the mixture, thereby effectively preventing the residual bubbles. Accordingly, such embodiments can reduce or remove the possibility of irregular physical properties, interface defects, and the degradation of the mechanical strength. In addition, the temperature range may maintain the thermal stability of the mixture. Accordingly, the temperature condition may prevent the resin composition from being thermally decomposed or prevent an earlier curing reaction due to an excessive increase in temperature, thereby ensuring the quality and the reliability of the composition.

Hereinafter, embodiments of the present disclosure will be described in detail so that those of ordinary skill in the art to which the present disclosure pertains may readily reproduce the present disclosure. However, the present disclosure may be realized in various different forms, and is not limited examples described herein.

### Examples and Comparative Examples

### Example 1

Polyurethane-based resin (NEOREX by P-4030) was maintained and degassed under the conditions of 1 Pa and 80° C. for 30 minutes, and 4,4′-methylenebis(2-chloroaniline) was maintained and degassed under at 1 Pa and 80° C. for 30 minutes. Thereafter, a primary mixture was prepared by mixing 100 g of the degassed polyurethane-based resin with 2.29 g of silica nano-powders (Lot #MKCJ8466 by Sigma-Aldrich). Then, 12.2 g of the degassed 4,4′-methylenebis(2-chloroaniline) (NEOREX) as the curing agent was mixed with the above prepared primary mixture to prepare a secondary mixture. Thereafter, the secondary mixture was poured into a mold, and was vacuum-degassed under the conditions of 1 Pa and 25° C. for 10 minutes to prepare the thermosetting resin composition.

### Example 2

Thermosetting resin composition was prepared in the same manner as that of Example 1, except that 1.8 g of the silica nano-powders (Lot #MKCJ8466 by Sigma-Aldrich) were introduced, instead of 2.29 g, and 18.5 g of the degassed 4,4′-methylenebis(2-chloroaniline) (NEOREX) was introduced, instead of 12.2 g.

### Comparative Example 1

Polyurethane-based resin (P-4030 by NEOREX) was prepared and used as the resin composition.

### Comparative Example 2

Polyurethane elastomer (Vulkollan by Covestro) was prepared and used as the resin composition.

### Comparative Example 3

Thermosetting resin composition was prepared in the same manner as that of Example 1, except that 1.00 g of the silica nano-powders (Lot #MKCJ8466 by Sigma-Aldrich) were introduced, instead of 2.29 g.

### Comparative Example 4

A thermosetting resin composition was prepared in the same manner as that of Example 1, except that 3.00 g of the silica nano-powders (Lot #MKCJ8466 by Sigma-Aldrich) were introduced, instead of 2.29 g.

### Experimental Example

### Experimental Example 1: Evaluation of Tensile Properties Based on Presence of Silica Nano-Particles

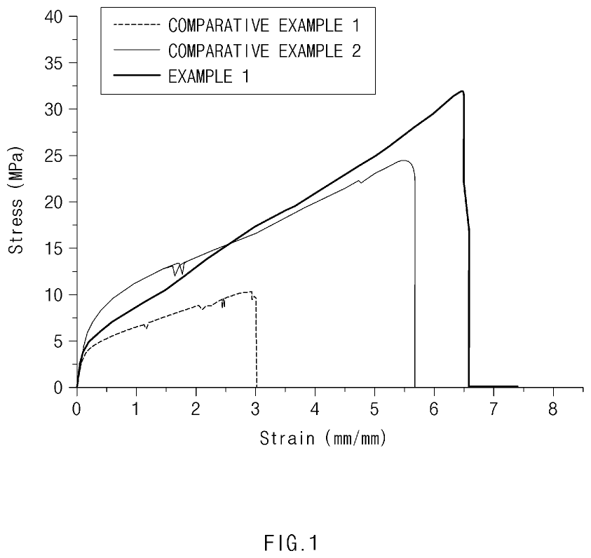

The thermosetting resin composition prepared in Example 1 and the resin compositions prepared in Comparative example 1 and Comparative example 2 were primarily cured at 120° C. for 60 minutes, and then secondarily cured at 110° C. for 15 hours to prepare a plate-shaped test sample having a width of 6 mm, a length of 25 mm, and a thickness of 3 mm. Thereafter, a tensile test was performed using Universal Testing Machine (UTM; model name 4466 by Instron), in compliance with ASTM D638. The tensile test was performed by applying tension to the test sample until the test sample was fractured in the state that a crosshead speed was set to 5 mm/min, thereby measuring the maximum stress and strain. The stress-strain relationship based on the measured result is illustrated in the form of a graph in FIG. 1.

Referring to FIG. 1, the data indicates that overall, Example 1 showed higher tensile strength and elongation, as compared to Comparative example 1 and Comparative example 2. In more detail, Comparative Example 1 (dashed line) and Comparative Example 2 (thin solid line) having no silica nano-particle exhibited maximum stresses of about 12 MPa and 25 MPa, respectively, and elongations of about 3.5 mm/mm and 6.0 mm/mm, respectively, thereby showing limited mechanical properties. In contrast, according to Example 1 (thick solid line) of the present disclosure, silica nano-particles were contained in the resin composition, providing for excellent tensile properties of the maximum stress of about 35 MPa and the elongation of about 6.5 mm/mm. Accordingly, this suggests that the silica nano-particles when uniformly dispersed into the polyurethane-based resin can improve the ability to transfer load and to prevent fine cracks from being transferred, thereby improving the mechanical strength and ductility of the resin composition.

### Experimental Example 2: Evaluation of Shear Properties Based on Content of the Silica Nano-Particles

The thermosetting resin composition prepared in Examples 1 and 2, and Comparative examples 3 and 4 were primarily cured at 120° C. for 60 minutes, and then secondarily cured at 110° C. for 15 hours to prepare a plate-shaped test sample having a width of 50 mm and a length of 50 mm. Thereafter, specific shear stress of 16 MPa was applied to the prepared plate-shaped test sample, and a shear creep test was performed while maintaining a higher-temperature environment corresponding to a 20-times accelerated condition. The shear creep test was performed by mounting a shear jig for a creep test on Universal Testing Machine (UTM; Model No. 4466 by Instron). The maximum measurement time was set to 5,400 s, an elapsed time until the plate-shaped test sample could no longer sustain the load and was fractured, was defined as a fracture time (s) and was measured. The measurement results are shown in Table 1.

TABLE 1

| | Poly- | Silica nano- | Curing | Fracture |
|---|---|---|---|---|
| | urethane | particles | agent | time (s) |
| | (g) | (g) | (g) | @16 MPa |
| Example 1 | 100 | 2.29 | 12.2 | 313 |
| Example 2 | 100 | 1.80 | 18.5 | Maximum |
| | | | | measurement |
| | | | | time expired |
| Comparative | 100 | 0.00 | 12.1 | 5 |
| example 1 | | | | |
| Comparative | 100 | 1.00 | 12.2 | 113 |
| example 3 | | | | |
| Comparative | 100 | 3.00 | 12.2 | ~1 |
| example 4 | | | | |

According to Table 1, the fracture time was measured to 313 seconds which was a longer time for Example 1 including 2.29 parts by weight of the silica nano-particles based on 100 parts by weight of the polyurethane, and the fracture was not made in the maximum measurement time (5,400 s) at a shear stress of 16 MPa for Example 2 including 1.80 parts by weight of the silica nano-particles based on 100 parts by weight of the polyurethane. This implies that the dispersibility of nano-particles in the polyurethane-based resin can be produced and maintained, such that external force is effectively distributed and an interface bond is stabilized when the silica nano-particles is contained in a content ranging from 1.5 parts by weight to 2.5 parts by weight, based on 100 parts by weight of polyurethane-based resin.

In contrast, the significantly short fracture time was observed for Comparative example 1 in which the silica nano-particles are not mixed. In addition, it was observed that, when the content of the silica nano-particles was less than 1.5 parts by weight (Comparative example 3), the reinforcing effect was insufficient, and when the content of the silica nano-particles exceeded 2.5 parts by weight (Comparative example 4), the silica nano-particles were irregularly dispersed or the viscosity was increased and degraded the shear physical property. As illustrated in Comparative example 4, it was observed that shear load was applied while fracture immediately occurred to sharply decrease the durability, when the content of the silica nano-particles was not excessive.

According to the present disclosure, the thermosetting resin composition includes the thermoplastic polyurethane-based resin and the silica nano-particles, thereby simultaneously ensuring higher elasticity, higher strength, and excellent heat resistance.

In addition, according to the method for preparing the thermosetting resin composition of the present disclosure, the silica nano-particles may be effectively distributed in the thermoplastic polyurethane-based resin, thereby ensuring both the uniform dispersibility and the strength in the thermosetting resin composition.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present.

What is claimed is:

1. A thermosetting resin composition comprising:
polyurethane-based resin and silica nano-particles,
wherein the silica nano-particles are included in an amount ranging from 1.5 parts by weight to 2.5 parts by weight, based on 100 parts by weight of the polyurethane-based resin.

2. The thermosetting resin composition of claim 1, wherein the polyurethane-based resin includes:
one or more of polyester-based polyurethane, polyether-based polyurethane, and/or polycarbonate-based polyurethane.

3. The thermosetting resin composition of claim 1, wherein the silica nano-particles have an average particle diameter ranging from 10 nm to 20 nm.

4. The thermosetting resin composition of claim 1, wherein the silica nano-particles are included in an amount ranging from 1.8 parts by weight to 2.3 parts by weight, based on 100 parts by weight of the polyurethane-based resin.

5. A method for preparing thermosetting resin composition, the method comprising:
vacuum-degassing a thermoplastic polyurethane and a curing agent (S1);
mixing the vacuum-degassed thermoplastic polyurethane, the vacuum-degassed curing agent, and silica nano-particles to form a mixture (S2); and
vacuum-degassing the mixture (S3),
wherein the silica nano-particles are included in an amount ranging from 1.5 parts by weight to 2.5 parts by weight, based on 100 parts by weight of the vacuum-degassed thermoplastic polyurethane present in the mixture.

6. The method of claim 5, wherein the curing agent includes:
one or more of an isocyanate-based curing agent and/or an amine-based curing agent.

7. The method of claim 5, wherein the curing agent is vacuum-degassed at a temperature ranging from 100° C. to 150° C.

8. The method of claim 5, wherein the thermoplastic polyurethane is vacuum-degassed at a temperature ranging from 50° C. to 100° C.

9. The method of claim 5, wherein the vacuum-gassed curing agent is included in an amount ranging from 10 parts by weight to 15 parts by weight, based on 100 parts by weight of the vacuum-degassed thermoplastic polyurethane.

10. The method of claim 5, wherein the mixture is vacuum-degassed at a temperature ranging from 50° C. to 80° C.
